(19) United States
(12) Patent Application Publication
(10) Pub. No.: US 2015/0306755 A1
(43) Pub. Date: Oct. 29, 2015

(54) Multi-Functional Fuel Pump Lever Holding Device

(71) Applicant: Michael Hinds, Freeport, NY (US)

(72) Inventor: Michael Hinds, Freeport, NY (US)

(21) Appl. No.: 14/692,990

(22) Filed: Apr. 22, 2015

Related U.S. Application Data
(60) Provisional application No. 61/985,148, filed on Apr. 28, 2014.
(60) Provisional application No. 62/061,254, filed on Oct. 8, 2014.

(51) Int. Cl. B25F 1/00; B67B 7/16; B67D 7/42

(52) U.S. Cl. CPC B25F 1/00; B67D 7/42; B67B 7/16

(57) ABSTRACT

The present invention relates to a multi-function fuel pump lever holding device that retains a fuel pump lever in at least two activated, fuel-filling position and that also includes a means for removing a bottle cap and a means for opening at least a portion of the lid of a can. The device generally includes a first member and a second member extending from an end of the first member. At least two spaced apart arms extend from a middle portion of the first member in substantially the same direction as the second member. The two spaced apart arms form at least two locations for retaining a fuel pump lever in the engaged fuel-filling position. Further, each of the arms may include a means for retaining the fuel pump lever in position over the arm.

### CROSS REFERENCE TO RELATED APPLICATIONS

This application claims priority on U.S. Provisional Application Ser. No. 61/985,148, filed on Apr. 28, 2014, and U.S. Provisional Application Ser. No. 62/061,254, filed on Oct. 8, 2014, with the disclosures of each incorporated herein by reference.

### FIELD OF THE INVENTION

The present invention relates to a fuel pump lever holding device that may provide other functionality in addition to restraining the fuel pump lever in the engaged fuel filling position, and which may also be better tailored for fitting within the pocket of a driver when used as a key FOB.

### BACKGROUND OF THE INVENTION

The pumping of gasoline at a gas station to fill the tank of a driver's automobile became almost completely hands-free with the advent of the automatic pump nozzle (see e.g., U.S. Pat. No. 2,320,033 to Davis, U.S. Pat. No. 2,528,747 to Gravelle, and U.S. Pat. No. 3,589,413 to Vest). These automatic pump nozzles utilize a simple mechanism, which may initially be set by the gas station attendant or the car's driver, to hold the fuel filling lever at a position that enables the nozzle to dispense gas at a suitable rate, which occurs until the tank is full. Once the tank is filled, the mechanism is automatically deactivated to release the lever and stop the flow of gasoline.

Although, these devices generally operate properly and safely for the filling of a car's gas tank, they create a very slight indirect risk, which was first recognized in the mid-1990s. At that time, there were mysterious incidents of refueling fires occurring at gas station pumps. An investigation uncovered the fact that a person may accumulate a sufficient amount of static electricity on their body, which may be discharged upon touching a metallic portion of the pump nozzle after automatic refueling is completed, and which is sufficient to ignite gasoline vapors concentrated around the nozzle. A report by the Petroleum Equipment Institute attributes roughly 200 such fires to static discharge, rather than a spark from the car's engine compartment or an open flame from a driver seeking to light a cigarette near the gas pump (see e.g., (www.pei.org/PublicationsResources/SafetyResources/StopStaticCampaign.aspx).

The static electricity can be acquired from various different sources (i.e., by touching/scratching your own clothing such as a wool sweater, by walking across the carpet while shopping inside the gas station's mini-mart during the time that the gas is still pumping, etc.). However, it is common for a driver to re-enter his/her vehicle and wait therein for the hands-free fueling to be completed, and may thereby acquire a static charge by contact of the driver's clothing with the car's seat (see, www.youtube.com/watch?v=tuZxFL9cGkI).

Two states—New Jersey and Oregon—mandate that a consumer's automobile gas tank is to be refilled only at a full-service station (i.e., where a gas station attendant pumps the gas), however, the New Jersey ban on self-service gas stations dates back to a 1949 law, and the Oregon law dates back to 1951. It is also illegal to pump your own gas in the N.Y. town of Huntington, on Long Island. A number of other states had at one time legislated such a ban on self-service stations, but later reversed the ban.

However, even where these self-service bans require gas station attendants to pump the gasoline, the pumps still utilize the automatic nozzle feature, so that the service personnel may perform other tasks during the fuel filling period. Therefore, the gas station attendants may nonetheless run the risk of acquiring a static electric charge on their body, and of causing a static discharge resulting in a fire. Moreover, despite the fact that some gas stations have been removed or disabled these automatic filling devices on the nozzle of each of its pumps, it is common for people to merely jam the fuel tank cap beneath the lever to accomplish hands-free fuel dispensing. Such practice has, in part, been supplanted by the purchase and utilization of a separate clip that can be removably fixed to the pump nozzle to similarly hold the lever at a suitable position to dispense gas at a desired rate. One example is shown by the clip disclosed in U.S. Pat. No. 5,118,074.

In either case (i.e., when using the integral mechanism on the pump nozzle or the after-market clip), these devices provide more than a mere conveyance, particularly during the winter months in regions outside of the sunbelt where temperatures may be below freezing for extended periods of time, and a person could suffer from hypothermia or frostbite while filling up their car's gas tank. The problem is exacerbated for owners of large sport utility vehicles which have correspondingly large fuel tanks that require a longer time to be filled. So, it is very unlikely that any state will ever pass a law mandating that a person must stand there with their hand in constant contact with the pump nozzle throughout the time that gas is being dispensed, so that the/she avoid any possibility of acquiring a static charge on their person.

Therefore, the present invention is directed to an improved pump lever holding device which provides additional functionality. The improved device disclosed herein is adapted to provide a warning feature to warn the person dispensing gasoline, that they should discharge themselves on a metallic object prior to touching the nozzle, such as their car's door, to alleviate the potential for static discharge at the pump. The warning may require affirmative action on the part of the person prior to removal of the nozzle or thereafter, to encourage awareness of the problem. The device of the present invention is also adapted to fold into a more compact shape that may be more conveniently carried in the user's pocket. In addition, the present invention may provide added functionality by including a feature that allows a person to remove a cap from a bottle, and to pierce one or more holes in the lid of a can to access the liquids therein.

### OBJECTS OF THE INVENTION

It is an object of the invention to provide a multi-functional fuel pump lever holding device that, in addition to retaining a fuel pump lever in an engaged fuel filling position, includes a means for removing a bottle cap and a means for piercing the lid of a can.

It is another object of the invention to provide a multi-functional fuel pump lever holding device that provides its user a warning as to the potential danger from a static electrical discharge near the gas pump nozzle.

Further objects and advantages of the invention will become apparent from the following description and claims, and from the accompanying drawings.

### SUMMARY OF THE INVENTION

The present invention relates to a multi-functional fuel pump lever holding device that retains a fuel pump lever in at least two activated, fuel-filling positions, and also includes a warning means and a means for removing a bottle cap and a means for opening at least a portion of the lid of a can. The device generally includes a first member and a second member extending from an end of the first member. At least two spaced apart arms extend from a middle portion of the first member in substantially the same direction as the second member. The two spaced apart arms form at least two locations for retaining a fuel pump lever in the engaged fuel-filling position. Further, each of the arms may include a means for retaining the fuel pump lever in position over the arm.

The bottle cap removing means or the can piercing means may be located on an end of the first member or on an end of the second member that is distal to the first member. Further, the can piercing means or the bottle cap removing means may be located on an end of the first member that is opposite to the end of the bottle cap removing means or the can piercing means when the bottle cap opening or the can piercing means is located on an end of the first member. Further, when the bottle cap opening means or the can piercing means is located on the end of the second member that is distal to the first member, the can piercing or bottle cap opening means may be located on the end of the first member proximal to the second member's extension point or the end of the first member that is distal to the location of the second member.

In operation, the device of the present invention may be placed on a fuel pump handle and the fuel pump lever lifted and supported by one of the two spaced apart arms to retain the lever in an engaged fuel-filling position. When the device of the present invention is not used as a fuel pump lever holder, the device may be used as a bottle cap opener or as a can opener by piercing holes in the lid of a can.

### BRIEF DESCRIPTION OF THE DRAWINGS

FIG. 1A shows a perspective view of a prior art fuel pump lever holding device in use, having been removably fitted to a fuel pump handle.

FIG. 1B shows a front view of the prior art fuel pump lever holding device and fuel pump handle of FIG. 1A.

FIG. 2 shows a side view of an improved fuel pump lever holding device of the present invention.

FIG. 2A is a top view of the improved fuel pump lever holding device of FIG. 2.

FIG. 2B shows an alternate embodiment for the can opener portion of the improved fuel pump lever holding device of FIG. 2.

FIG. 2C shows an alternate embodiment of the improved fuel pump lever holding device of FIG. 2.

FIG. 3 shows a side view of an alternate embodiment of the pump lever holding device of FIG. 2, in which both of its two fuel pump lever support arms are pivotable, and are shown after being pivoted into the extended position.

FIG. 4 is the pump lever holding device of FIG. 3, but shown with both of the lever support arms having been pivoted into the retracted position.

FIG. 5 is the pump lever holding device of FIG. 3, but shown with the upper lever support arm in the extended position, and the lower lever support arm in the retracted position.

FIG. 6 is the pump lever holding device of FIG. 3, but shown with the upper lever support arm in the retracted position, and the lower lever support arm in the extended position.

FIG. 7 shows a side view of a second alternate embodiment of the pump lever holding device of FIG. 2, in which both of the two lever support arms are pivotable, and are shown in the retracted position, and with each being individually coupled to a spring biased warning shield that is configured to pivot to expose a warning sign, when one of the two arms is moved into its extended position.

FIG. 8 is the pump lever holding device of FIG. 7, in which the lower support lever has been pivoted into the extended position, resulting in release of the shield latch and biasing of the warning shield into its open position.

FIG. 8A is a top view of the pump lever holding device of FIG. 8, showing the warning label on the hook portion of the device and on the exposed underside of the shield.

FIG. 9 is the pump lever holding device of FIG. 8, in which the lower support lever has been pivoted back into the retracted position, but with the warning shield still being biased into its open position.

FIG. 10 is a side view of a third alternate embodiment of the pump lever holding device of FIG. 2, in which both of the two lever support arms are pivotable, and are shown in the retracted position, and with each being individually coupled to a spring biased warning shield that is configured to move to expose a warning sign, when one of the two arms is moved into its extended position.

FIG. 10A shows a top view of the warning shield that is used in the embodiment of FIG. 10.

FIG. 10B shows a top view of the shield support member that is used in the embodiment of FIG. 10.

FIG. 10C shows a first version of the warning sign for the embodiment of FIG. 10.

FIG. 10D shows a second version of the warning sign for the embodiment of FIG. 10.

FIG. 11 shows a perspective view of a fourth embodiment of the device of the present invention that includes an end of the first member distal to the second member that is open ended with a point for placing under the lid of a bottle cap for removing the bottle cap.

FIG. 12 shows a perspective view of a fifth alternate embodiment of the device of the present invention wherein the bottle cap opening means includes an opening along the body of the first member near the end of the first member that is distal to the second member. The opening is adapted to receive a bottle cap and includes a lip along at least a portion of its edge for placing under a bottle cap to remove the bottle cap.

FIG. 13 shows a perspective view of a further alternate embodiment of the present invention wherein the bottle cap removing means includes a structure extending from an end of the first member that is distal to the second member wherein the structure has an opening with a lip along a portion of its inner edge for placing under the lid of a bottle cap to remove the cap.

FIG. 14 shows a perspective view of an alternate embodiment of FIG. 11 of the present invention wherein the second member is curved.

FIG. 15 shows a perspective view of a further alternate embodiment of FIG. 11 wherein the can piercing means and bottle cap removing means have switched positions from FIG. 11.

### DETAILED DESCRIPTION OF THE INVENTION

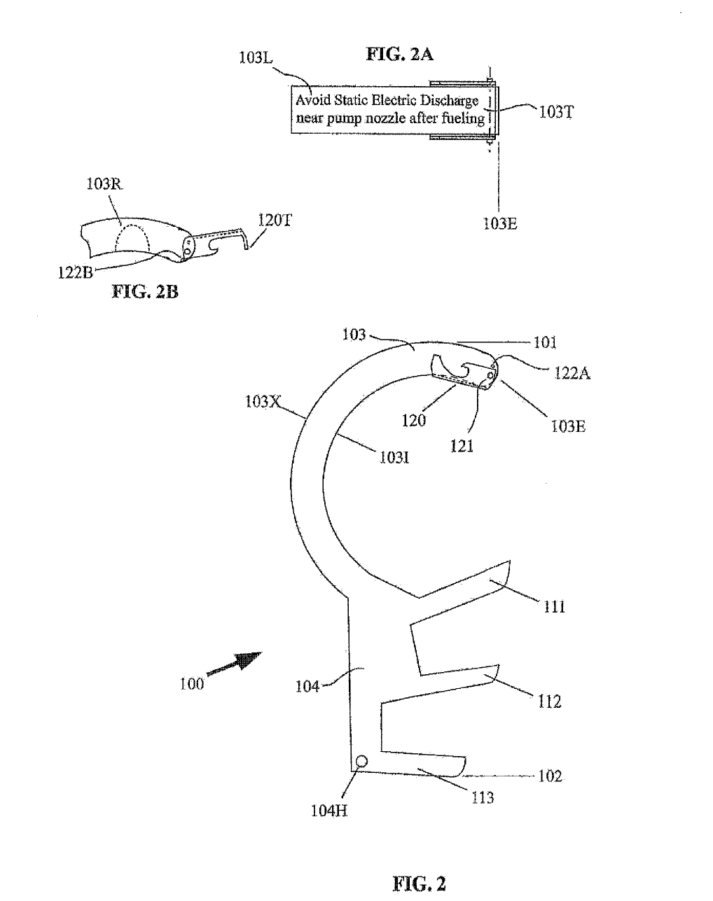

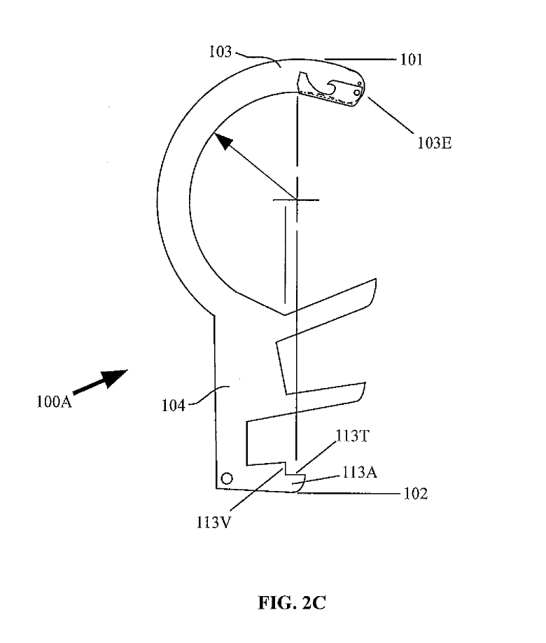

The multi-functional fuel pump lever holding device 100 shown in FIG. 2 is configured to hold a fuel pump lever in an engaged fuel filling position, while also providing a means for removing a bottle cap and/or for piercing a hole in the lid of a can.

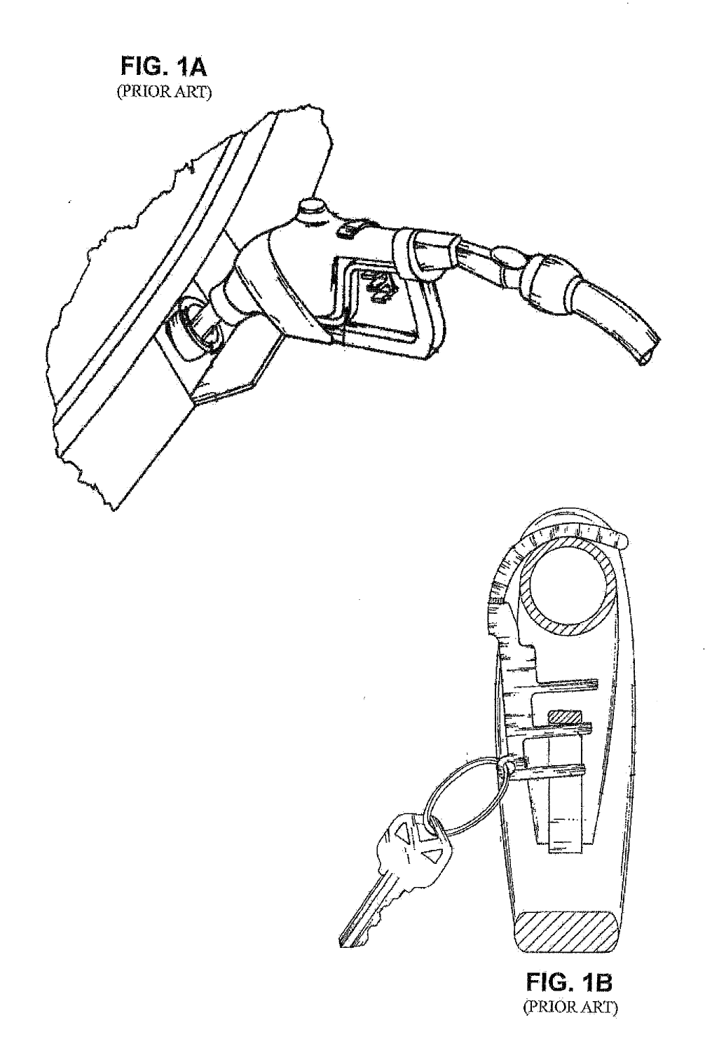

The fuel pump lever holding device 100 may have a first end 101 and a second end 102, and may include an upper portion 103 that may be configured to fit over the top surface of the handle portion of a fuel pump nozzle, as seen in FIG. 1A. The upper portion 103 may preferably have a curved interior side 1031 and a curved exterior side 103X, each of which may, but need not necessarily be, formed as a substantially cylindrical surface. The top 103T of the curved exterior side 103X of upper portion 103 may have lettering 103L stenciled thereon (FIG. 2A), or the lettering may be added in any other suitable manner (e.g., by a applying a sticker thereto). The lettering 103L may warn the user of the danger of a gas pump nozzle fire due to an electrical discharge, and may state, for example, “Avoid Static Electric Discharge Near Gas Pump Nozzle After Fueling.”

The upper portion 103 may transition into an elongated lower portion 104. The lower portion 104 may generally extend away from the upper portion 103, and may have one or more arms extending laterally therefrom. The fuel pump lever holding device 100 of FIG. 2 is shown with a first arm 111, a second arm 112, and a third arm 113. The arms may be positioned at successively further distances from the first end 101, in order that they provide for holding of the fuel level of the pump nozzle at different positions, to penult correspondingly different fuel flow rates. This enables the user to choose an appropriate flow rate for dispensing of gasoline into the tank through his/her selection of the arm that is used to hold the lever.

Since the arm 113 is farthest away from the first end 101, it will deflect the fuel level of the pump nozzle the least amount, and will consequently provide for the dispensing of gas at the slowest rate. This “slow” rate of fuel dispensing is construed herein to mean the lever of the fuel pump handle has been actuated to a position between about 5 percent to about 25 percent of its maximum travel. Arm 112 is closer to the first end 101 and will actuate the spring biased fuel pump lever more than would arm 113, and thus would provide for a somewhat faster dispensing rate for the gasoline. Similarly, arm 111 is closest to first end 101 and will actuate the spring biased fuel pump lever the most, and, of the three arms on the device 100, would produce the fastest dispensing rate for the gas. Since arms 112 and 111 are successively closer to the first end 101 and would correspondingly need to oppose an incrementally larger biasing force provided by the fuel pump lever, they may each be angled upwardly with respect to the end 103E of the upper portion 103, to better assure retention of the lever at that position. The lowermost arm 113 may similarly be angled upwardly.

Alternatively an arm 113A, as shown in FIG. 2C, may have a top surface 113T that is oriented to be perpendicular to the direction of the restraining force that may be used for retraining the fuel pump lever to continuously pump fuel. (Note, the restraining force is shown vertical therein, and is generally determined by the constraining distance provided by the arms of the device). With the arm 113A also configured to have a shortened length extending perpendicularly from a wall 113V therein (where wall 113V may be parallel to the line of force), so that the length is only equal to the width of the fuel pump lever arm, this may allow the fuel pump lever to automatically pop off of the arm 113A, once fuel filling is complete and the fuel pump valve causes the fuel pump lever/handle to kick. The extent of the top surface 113T should be generally centered/symmetric with respect to the line of force, for the fuel pump lever to normally pop off To assist with retaining the fuel pump lever upon the shortened arm, a very slight upward angle may be used for the top surface 113T, being significantly smaller than the angle shown and used for arms 111 and 112, so that the lever may still pop off automatically, with the angle being only in the range of approximately one degree to five degrees. (Note that use of the slight angle may assist in retaining the fuel pump lever thereon by applying the force to the bottom outside edge of the pump lever, rather than being distributed thereon). Shorter lengths for the arm 113A may also be used, being shorter than the width of the lever arm, but where the distance from the wall 113V to the line of force may remain roughly one-half of the width of the fuel pump lever. Because the end 103E of the top curved upper portion 103 may extend beyond the line of force, and around the top of the fuel pump handle, once the fuel pump lever/handle kicks and causes the lever to pop off of the shortened arm 113A, the pump lever holding device 100A may still be left hanging from the top of the pump handle. (Note, this configuration for the lowermost arm 113A may also be used for the upper arms as well).

An end of the lower portion 104 of the fuel pump lever holding device 100 may have a hole 104H therein that may be configured to receive a key ring, which may be used to retain the user's car key(s) and other keys.

The upper portion 103 may have a bottle opener 120 be pivotally attached at 121 to be proximate to its distal end 103E. A first spherical recess 122A and second spherical recess 122B formed in the side(s) of the upper portion 103 (FIGS. 2 and 2B) may be configured to receive a corresponding protrusion on the inner surface of the side(s) of the bottle opener 120, to serve as a detent to respectively hold the opener in a deployed position, so that it can be conveniently utilized to open a series of bottles, as seen in FIG. 2B, or to hold it in a retracted position. Alternatively, a friction fit may be used at the pivotal connection 121 to retain the bottle opener 120 at a desired position with respect to the upper portion 103. Also, so that the opener 120 may be used as both a bottle opener and a can opener, its tip 120T may be triangular in shape, forming a central sharp point, which may be received in a recess 103R in the upper portion 103 (see FIG. 2B), when the opener is moved into the stowed position.

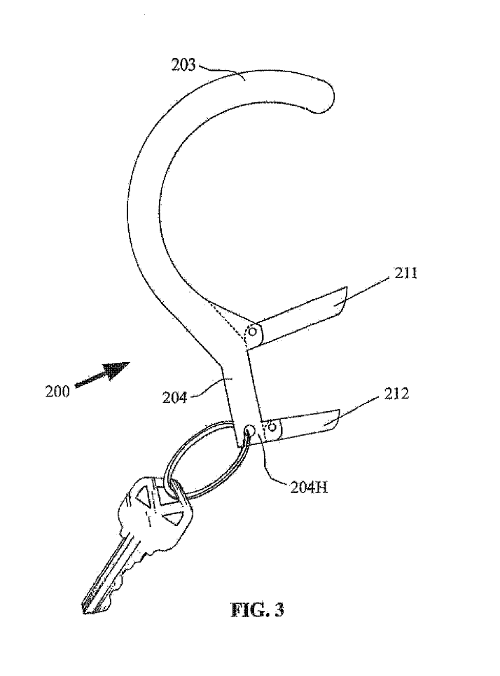

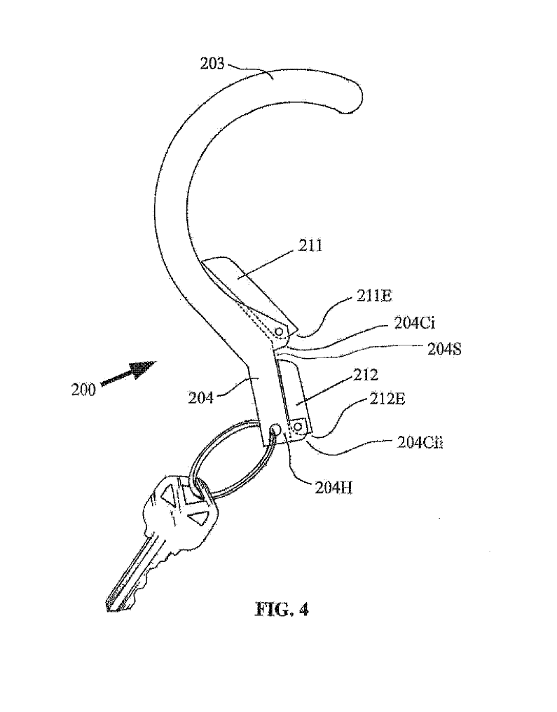

FIG. 3 illustrates a fuel pump lever holding device 200 that is constructed similar to device 100, but may instead have a first arm 211 and a second arm 212, which are pivotally attached to the lower portion 204. The arms 211 and 212 are both shown in the extended position in FIG. 3, and both are shown in the retracted position in FIG. 4. As seen in FIG. 4, with the arms 211 and 212 both moved into the retracted position, the device 200 is streamlined to occupy a smaller envelope, and may easily and more comfortably fit within the pocket of a user. (Note that the end of the lower arm 212 shown in FIG. 6 may also have the bottle opener 120 pivotally attached thereto, the same as fuel pump lever holding device 100, to provide for a multiplicity of functionality). The aims 211 and 212 may each be pivotally connected to the holding device 200 using, for example, a clevis extending from the lower portion 204 at suitable locations (e.g., clevis 204Ci and 204Cii). Each of the arms 211 and 212 may be rigidly supported in the extended position in order to be able to restrain the fuel pump lever arm, by the respective ends (211E and 212E) of the arms shown in FIG. 4 butting up against the side 204S of the lower portion 204.

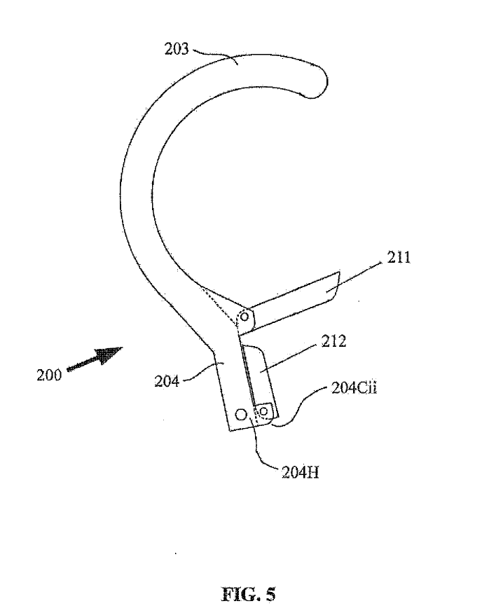

When the driver stops to get gas and utilize device 200, he/she may move the desired arm (211 or 212) from its retracted position into the extended position, as seen in FIGS. 5 and 6, depending upon the rate of fuel filling that is desired, and which may be optimum for the car's gas tank filler neck (i.e., the tube that receives the gas pump nozzle therein).

The upper portion 203 of fuel pump lever holding device 200 may have a bottle opener pivotally attached thereto, the same as for device 100, and may also have a key hole 204H for attachment of the key ring.

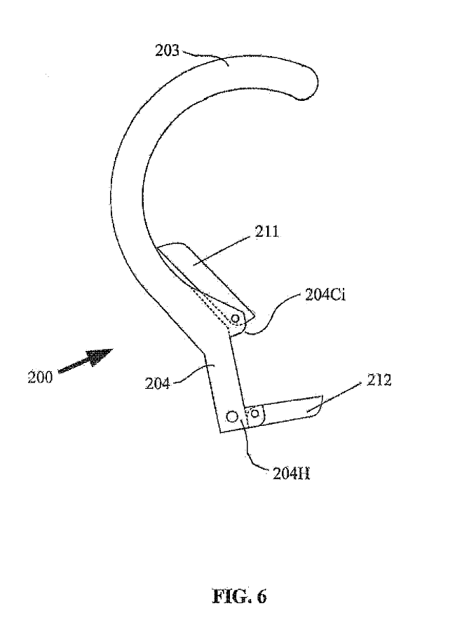

FIG. 7 illustrates a fuel pump lever holding device 300 that is constructed similar to device 200, having pivotal arms 311 and 312, each of which may hold a fuel pump lever in an engaged fuel filling position, and may also activate a warning means. The warning means may be configured to provide a warning to the person dispensing gasoline, as to the potential hazard of discharging static electricity near the pump nozzle. In this embodiment, instead of placing a warning label or decal on the top of the device, the warning means may provide a more active warning, which may require affirmative action on the part of the user to reinforce the warning.

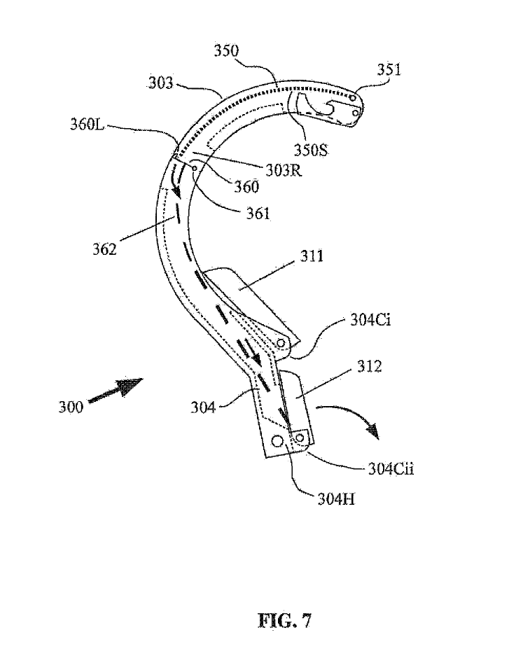

The fuel pump lever holding device 300 in FIG. 7 is shown with a shield 350 that may be positioned within a recess in the upper portion 303, and may be pivotally attached thereto at 351. The pivotal attachment at 351 may include a torsion spring (not shown) that is configured to bias the shield 350 to pivot out from the recess into the position shown in FIG. 8. A lever arm 360 may also be pivotally attached to the upper portion 303 at 361, and may also be biased by a torsion spring (not shown) to pivot in a clockwise direction when looking at FIG. 7. A shield support member 350S (see FIG. 8) may limit pivotal travel of the lever arm 360 to be at the position shown in FIG. 7. A lip 360L on the end of the lever arm 360 may block the spring biased shield from pivoting outwardly, when the lever is in contact with the stop. A flexible connector means 362 (e.g., a beaded pull chain normally used for lamps, a thin flexible wire, a string, or a cord, etc.) may be used to couple a portion of the lever arm 360 to a portion of the lower arm 312 near its pivotal connection with clevis 304Cii. Another flexible connector means (not shown) may similarly be used to independently couple the lever arm 360 to the upper arm 311. The description of the operation of the flexible connector means 362 in relation to the lower arm 312 is similarly applicable for the operation of the other connector means and the upper arm 311.

As seen in FIG. 7, when the driver needs to utilize the fuel pump lever holding device 300 to pump gas into his/her gas tank in a hands-free manner, and pivots the lower arm 312 from the retracted position shown therein to the extended position of FIG. 8, the flexible connector means 362 is actuated (i.e., pulled tautly) by the pivotal motion of the lower arm 312. The flexible connector means 362 thereby opposes the bias of lever arm 360 and causes the lever arm to pivot slightly in the counterclockwise direction. When the lip 360L of the lever arm 360 no longer restrains the spring-biased warning shield 350, the torsion spring at 351 biases the shield into the extended position of FIG. 8.

Each of the arms 311 and 312 may be retained in its respective extended position using a friction fit at its pivotal connection, whereby the friction fit is sufficient to oppose the biasing of the lever arm 360 that is provided by the torsion spring at 361. Alternatively, a detent may be used to hold each of the arms 311 and 312 in the extended position (see e.g., protrusion 311P and recess 304P in FIG. 8), similar to the detent arrangement that was used for the can opener 120 of device 100.

The user may removably affix the device 300 to the pump nozzle to hold the lever in an actuated position to pump gas, with it being retained between the upper portion 303 and the extended lower arm 312 of the device. As seen in FIG. 8A, the top of the shield support member 350S and the shield 350 may each have lettering placed thereon. In addition to the lettering on the shield support member 350S, which may similarly recite the warning used on device 100 (i.e., “Avoid Static Electric Discharge Near Gas Pump Nozzle After Fueling”), the space on the now exposed underside of the shield member 350 may further encourage the driver to refuel in a safer manner by reciting: “Touch Metal Car Door Before Touching Gas Pump Nozzle.”

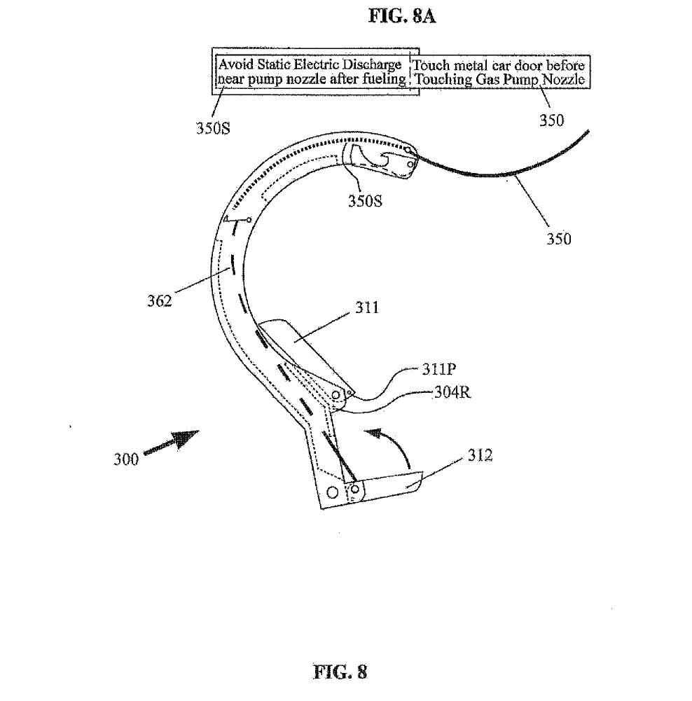

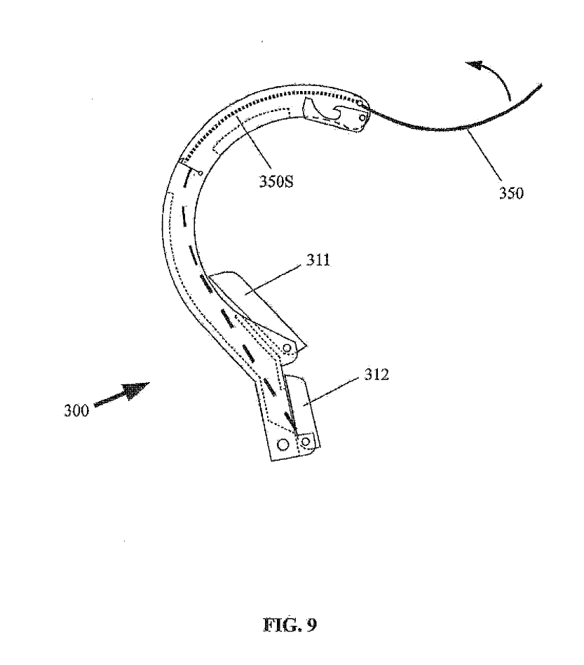

When refueling is completed and the pump has ceased to dispense gasoline, the driver may remove the device 300 from the pump nozzle, and may move the lower arm 312 back into the retracted position, as seen in FIG. 9. Next, in order for the user to place the device 300 back into his/her pocket (or in order to more conveniently use the keys secured thereon in the car's ignition switch), the driver may counter-rotate the shield 350 back toward its retracted position. The top of the lip 360L may be angled, so that when the bottom edge of the free end of the shield 360 contacts it, the lever arm 360 is deflected and pivots in opposition to its biasing, and once the shield contacts the support member 360S, the lever is biased back into contact with the support member 350S to again retain the shield thereat, in its retracted position. It should be noted that this warning shield 350 and related parts of device 300 may instead be incorporated into the refueling pump nozzle to be retained thereat, rather than being a separate clip that is carried and used individually by each motorist.

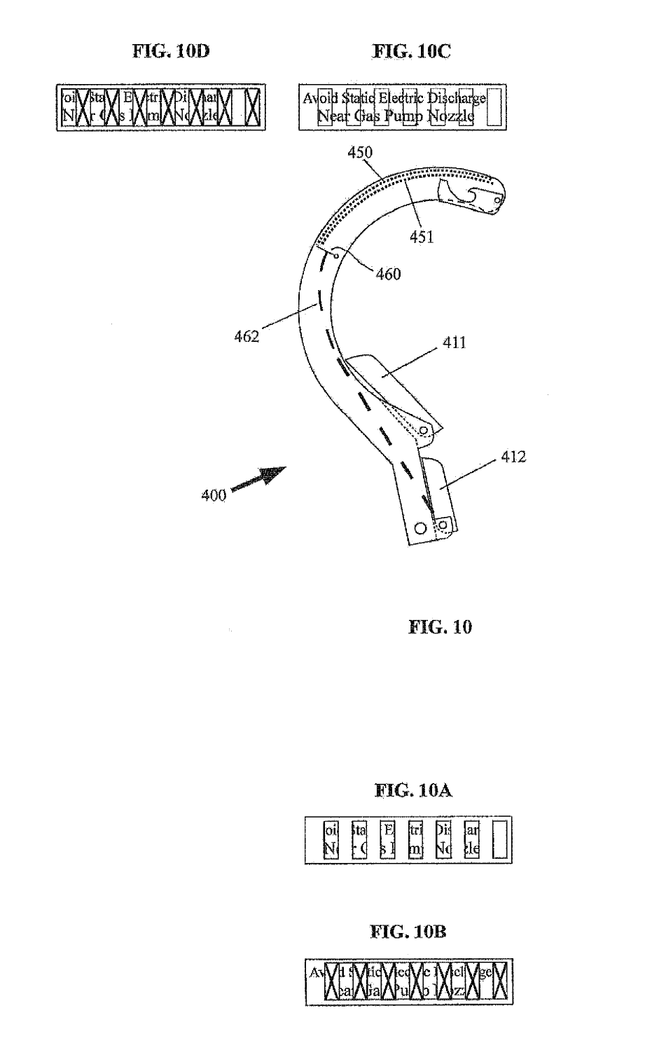

FIG. 10 illustrates a fuel pump lever holding device 400 that is also constructed similar to device 200, with pivotal arms 411 and 412, but which also includes a warning means that does not by itself require separate resetting by the driver, as with device 300.

For fuel pump lever holding device 400 the warning shield 450 may be flexible, and one end of the shield may be secured to the lever arm 460, so that it may move when the lever arm is actuated. The shield 450 may be constructed so that it contains alternating sections that are translucent, where the remaining sections may have portions of lettering thereon, as seen in FIG. 10A. The support member 450S may have alternating sections that contain portions of lettering thereon, and the remaining portions may include a brightly colored warning pattern, which is denoted in FIG. 10B by the “X” within the elongate rectangular shapes.

When the support arms 411/412 are in the stowed position, as seen in FIG. 10, the shield 450 may directly overlie the support member 451, and the portions of the lettering on the support member may be seen through the translucent portions of the shield 450, and together with the text portions of the shield, the full textual warning may be visible, as illustrated in FIG. 10C. When the user moves one of the arms into the extended position, the shield 450 may move to reveal the brightly colored warning pattern of the support member 451, as seen in FIG. 10D. The warning pattern may serve as a reminder to the driver to discharge themselves prior to grasping the pump nozzle when refueling is complete.

Alternatively, the lettering, the shield, and shield support member may instead be constructed so that the lettering is intact and fully readable when the user extends one of the arms to utilize the device. In this way, the textual warning will be visible to the driver when he/she seeks to grasp the nozzle to remove it from the gas tank filler neck. As with device 300, the text for device 400 may also include a reminder to discharge any possible static electricity on the car's door before grasping the nozzle. The device may be made wider if necessary to accommodate the required lines of text.

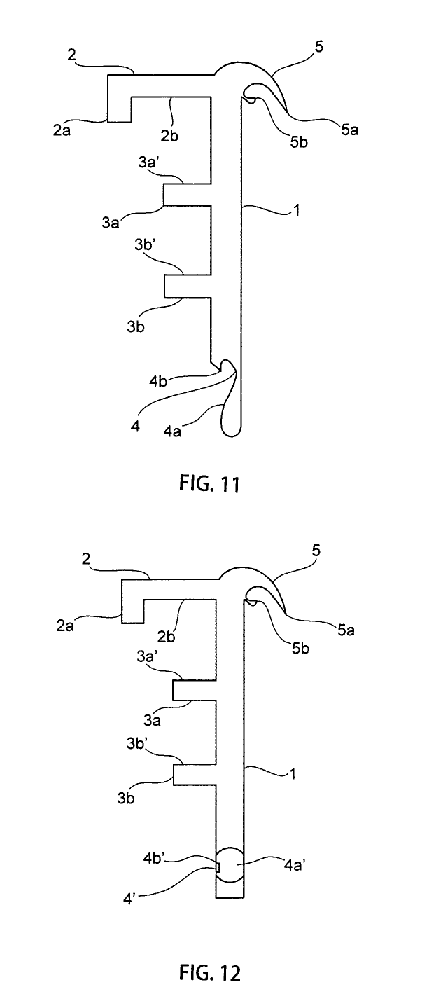

The fuel pump lever holding device of FIG. 11 generally comprises a fuel pump handle holding portion, and one or more arms extending from an elongate portion. The arms are adapted to retain the fuel pump lever in at least one of two engaged filling positions. The fuel pump lever holding device also comprises a can opening means at the end of either of the fuel pump handle holding portion or the elongate portion; and a bottle cap opening means at a different end than the fuel pump lever.

More specifically, the fuel pump lever holding device comprises a first member I and a second member 2 perpendicularly extending from the top end portion of the first member. The end of the second member distal to the first member may have a downward extending arm portion 2a to form a hook-like second member; however, in other embodiments, the second member may be a straight member without a downward extending portion. The second member and upper portion of the first member combine to form the fuel pump handle holding portion. The bottom surface 2b of the second member 2 is the surface that contacts the fuel pump handle. The bottom surface may be substantially flat or it may have a concave profile or other curved profile to allow for a better grip of the top surface of the fuel pump handle. The second member and upper portion of the first member may also combine to resemble a hook like configuration as is seen in FIG. 14. Here, the second member 2 has an arcuate profile to further aid in securing the device of the present invention to the handle of a gas pump. Further the distance the first member extends away from the first member is preferably a distance that is suitable for keeping the device of the present invention secured to the fuel pump.

At least a first arm 3a and a second arm 3b may extend in a spaced apart relation from around the mid-portion of the first member 1. The first and second arms extend in the same direction as the second member 2. The fuel pump lever may be received by the top surface 3a′ and 3b′ of either of the first or second arm 3a and 3b to be retained in the position associated with either of the first or second arms. Each of the first and second arms 3a and 3b may be substantially straight or their top surface may be curved to facilitate a better restraining of the fuel pump lever. Even further, each of the first and/or second arms 3a and 3b may have a curved top surface to better receive and retain the fuel pump lever while the bottom surface of each arm is substantially straight. In an embodiment, the top surface of one or both arms may have a concave profile to better restrain and secure the fuel pump lever. The arms preferably extend to a distance that is suitable for receiving and retaining a fuel pump lever.

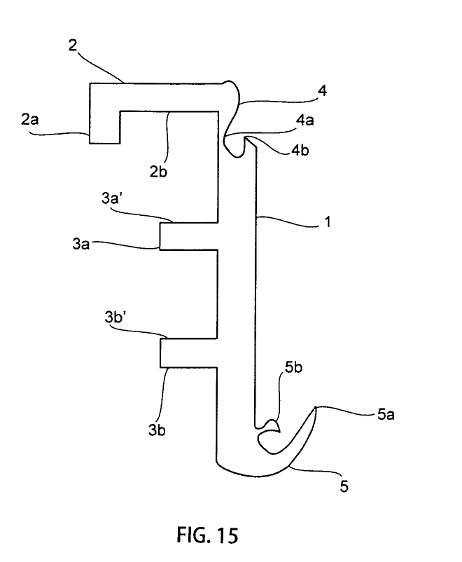

The multi-function fuel pump lever holding device is further intended to have a “church key” functionality wherein one end of the first member may have a bottle cap removing means 4 and an opposite end of the first member may have a can piercing means 5. Alternatively, the end of the second member distal from the first member may have the can piercing or bottle cap removing means rather than the respective end of the first member. FIG. 15 shows an embodiment of the present invention wherein the can piercing means 5 and bottle cap removing means 4 have switched positions from their positions in FIG. 11. Here, the bottle cap removing means 4 is located on the end of the first member that is proximal to the second member and the can piercing means 5 is located on the opposite end of the first member, i.e., the end of the first member that is distal to the second member. The bottle cap removing means in this embodiment may be any of the other bottle cap removing means described herein or any other bottle cap removing means known in the art.

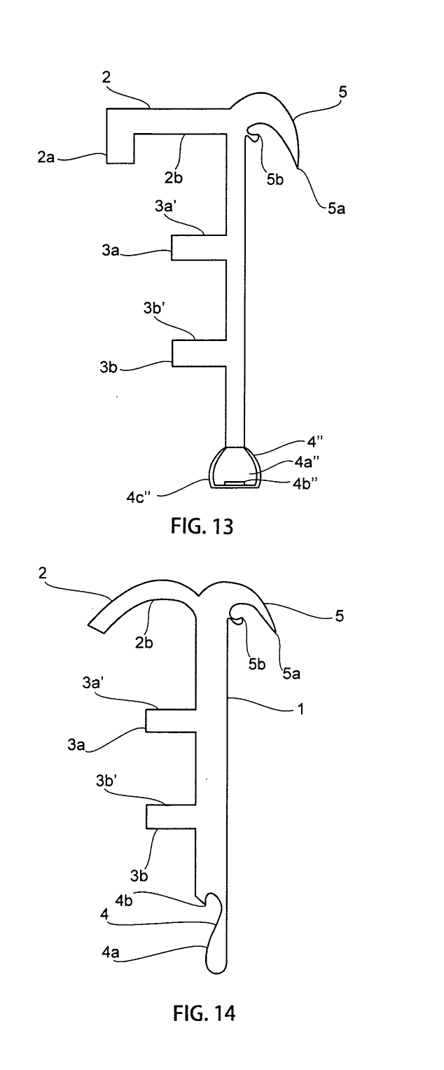

The bottle cap removing means 4 may be of the type that includes a rounded open end 4a with a point 4b for placing under the edge of a bottle cap (FIG. 11). Other bottle cap removing means may alternatively be used such as but not limited to an opening 4a′ at an end wherein at least a portion of the edge of the opening includes a protrusion 4b′ that is placed under the edge of the bottle cap to be removed (FIG. 12). Even further, the bottle opening means may comprise a structure 4c″ extending from an end of the first member that is distal to the second member wherein the structure has an opening 4a″ with a protrusion 4b″ along a portion of its inner edge for placing under the lid of a bottle cap to remove the cap (FIG. 13). It is contemplated by the present invention, however, that other bottle cap removing means known in the art may alternatively be used.

The can piercing means 5, as shown in FIG. 11, may be in the form of an end having a triangular pointed head 5a for piercing the lid of a can. There may also be a member 5b extending angularly extending away from the first member in the direction of the tip of the triangular pointed head. The member may have an end point that curves upward in the direction of the bottom surface of the triangular point head. The member may function as an aid for securing the device of the present inventions to the lid of a can when using the can piercing means of the device. Further, the member may also function as an additional bottle cap removing means. In further embodiments of the invention, the triangular point head 5a of the can piercing means 5 may extend in any other direction rather than away from the second member 2 and two extending arms 3a and 3b. For example, the triangular point head 5a and member 5b may extend in the same direction as the second member 2 and extending arms 3a and 3b or in a perpendicular, diagonal or any other direction with respect to the extending arms. Further, in an alternate embodiment, the can piercing means and/or bottle cap removing means may be removable from an end of the present invention's device by a threadable engagement with the end of the device.

Each of the extending arms 3a and 3b may further include a means for further securing the fuel pump lever to either of the first or second extending arms. The means may include a retractable member (not shown) that may be spring loaded and may protrude from the top surface of the extending arms. The member may be controlled by a push button activator such that the fuel pump lever may be placed in position over the top surface of either of the arms and the button pushed to cause the retractable member to pop out of the top surface of the arm and secure the lever to the arm. To return the retractable member to its retracted position, a user may push the member into the orifice on the top surface that receives the member and secure the member in the non-retracted position by, for example, a retractable lipped portion along a at least a portion of the inner edge of the orifice. Further, the spring loaded mechanism may have a means for securing the retractable member in a retracted position, such as preventing the member from extending when it has been retracted into the orifice to a certain degree. The retractable member is preferably located near the end of the arms distal to the first member and the retractable members preferably pivot in a direction towards the distal end of the arms when the member is being retracted and towards the first member when the retracting members are being extended into the non-retracted position. It is to be appreciated by those skilled in the art that means known in the art other than the push button activator may be employed to position the retractable member in a non-retracted position. These means include but are not limited to a slide button actuator or the retractable member being given a downward force to release it from the retractable position. The retractable member is intended to prevent the fuel pump lever from slipping off of either of the extending arms.

To further prevent the fuel pump lever from slipping off of the extending arms 3a and 3b, at least a portion of the top surface of the extending arms may be coated with a non-slip surface, such as a rubber surface. The extending arms may include the non-slip coating in addition to or rather than the retractable members. Even further, the second member may be equipped with a retractable arm extending from its bottom surface and/or a non-slip coating to aide in securing the device of the present invention to the fuel pump handle.

At least a portion of the body of the first member may be coated with a non-slip surface to enable a user to better grip and handle the present invention's device. In operation, the device of the present invention may be placed on a fuel pump handle and the fuel pump lever lifted and supported by one of the two spaced apart arms to retain the lever in an engaged fuel-filling position. When the device of the present invention is not used as a fuel pump lever holder, the device may be used as a bottle cap opener or as a can opener by piercing holes in the lid of a can.

The device of the present invention may be constructed of a metal, plastic or composite thereof. It is preferred that the can opening means and bottle cap removing means is constructed of a metal or metal composite material even if the remaining portions of the device is constructed of a plastic or different metal or metal composite than the can piercing and bottle cap removing means.

1. A combination fuel pump lever holding device and bottle cap removing device, wherein the fuel pump includes a handle against which the lever is squeezed to allow fuel to flow, said combination device comprising:
a curved member having a first end and a second end;
an elongated member configured to extend away from said second end of said curved member;
an arm configured to extend laterally from said elongated member; and
bottle cap removing means, said bottle cap removing means configured to be pivotally mounted to said first end of said curved member, to be pivotable between a retracted position, and an extended position in which said curved member and said elongated member provide leverage to effect removal of the bottle cap.

2. The combination device according to claim 1, further comprising a detent configured to releasably secure said bottle cap removing means in said first position.

3. The combination device according to claim 2, further comprising a hole proximate to an end of said elongated member being distal from said curved member, said hole thereby configured to receive a key ring.

4. The combination device according to claim 3, wherein the hook member comprises a cylindrical shape, and wherein said arm is positioned at a distance from an axis of said cylindrically shape curve member, to effect slow dispensing of fuel.

5. The combination device according to claim 4 further comprising a second arm configured to extend laterally from said elongated member at a position between said first arm and said curved member, being at a second distance from the axis of said cylindrically shape curve member, to effect more rapid dispensing of fuel.

6. The combination device according to claim 1, wherein said detent is further configured to also releasably secure said bottle cap removing means in said second position.
